(19) United States
(12) Patent Application Publication
(10) Pub. No.: US 2009/0155753 A1
(43) Pub. Date: Jun. 18, 2009

(54) Behavior Tracking with Tracking Pods

(75) Inventors: Thomas Michael Ales, Neenah, WI (US); Andrew Mark Long, Appleton, WI (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC., Neenah, WI (US)

(21) Appl. No.: 11/956,651

(22) Filed: Dec. 14, 2007

(51) Int. Cl. G09B 19/00

(52) U.S. Cl. 434/236

(57) ABSTRACT

In one embodiment of the present disclosure, a system for tracking behavior is described. The system includes at least one computing device adapted to receive data from at least one tracking pod, generate at least one report utilizing at least a portion of the data, and provide a user access to the data and the at least one report. The data indicates a behavior.

### BACKGROUND

Parents and caregivers strive to learn the natural patterns of behavior for their children so that they can better care for and understand them. Currently, several software programs exist that enable parents to input detailed data and create informative records about children's various behaviors. For instance, programs allow parents and caregivers to track feeding behaviors, excretory behaviors, sleeping behaviors, and the like. Similarly, such programs also allow parents and/or caregivers to monitor some of their own activities that have a direct relation to a child's health and/or well-being. Such behaviors can include breast feeding behaviors and dispensing of medicine, by way of example.

However, conventional software requires parents and caregivers to perform cumbersome data entry manually. Such data entry causes many to abandon the effort after a short period of time because they find it to be too time-consuming and tedious. Additionally, tired parents and caregivers are very likely to input information incorrectly leading to inaccurate information about behaviors.

In this regard, sensors have long been an important part of health care in hospitals and some managed care facilities. Recently many technologies have been proposed for sensors that can be used at home, including disposable or single-use devices. Further, technologies have been proposed that can be incorporated into another item that is worn on or near the body, such as a disposable diaper, training pant, and the like. Finally, it has also been proposed to use portable or disposable sensors equipped with electronic devices that can store or transmit data relevant to the health and well-being of a subject.

In this regard, a need exists for a system that allows parents and/or caregivers to automatically track various behaviors through the use of sensors. Such information would also be useful with regards to products that relate to such tracked behaviors. Particularly, the data collected could be helpful for trending towards product utility, design revisions, and marketing insights. Sensors for use in tracking the behaviors of children as well as their parents and/or caregivers, offer many opportunities for improved health and well-being.

### SUMMARY

Objects and advantages of the disclosure will be set forth in part in the following description, or can be obvious from the description, or can be learned through practice of the disclosure.

In one embodiment of the present disclosure, a system for tracking behavior is described. The system includes at least one computing device adapted to receive data from at least one tracking pod, generate at least one report utilizing at least a portion of the data, and provide a user access to the data and the at least one report. The data indicates a behavior as described more fully herein.

In another embodiment of the present disclosure, a method of tracking behavior is described. The method includes receiving data from a tracking pod, generating a report utilizing at least a portion of the data, and providing a user access to the data and the report. The data indicates a behavior as described more fully herein.

Other features and aspects of the present disclosure are discussed in greater detail below.

### BRIEF DESCRIPTION OF THE DRAWINGS

A full and enabling disclosure, including the best mode thereof to one of ordinary skill in the art, is set forth more particularly in the specification, including reference to the accompanying figures in which:

FIG. 1 is a flow chart illustrating one embodiment of a network including tracking pods, according to the present disclosure;

FIG. 2 is a flow chart illustrating further details of the tracking pods of FIG. 1;

FIG. 3 depicts one method for secure connection of a private network to a remote network via the Internet; and

FIG. 4 depicts a network configuration for providing restricted access of tracking pod information to physicians and authorized third parties.

### DEFINITIONS

As used herein, the term “analyte” generally refers to a substance to be detected. For instance, analytes can include antigenic substances, haptens, antibodies, and combinations thereof. Analytes include, but are not limited to, toxins, organic compounds, proteins, peptides, microorganisms, amino acids, nucleic acids, hormones, steroids, vitamins, drugs (including those administered for therapeutic purposes as well as those administered for illicit purposes), drug intermediaries or byproducts, bacteria, virus particles and metabolites of or antibodies to any of the above substances. Specific examples of some analytes include ferritin; creatinine kinase MB (CK-MB); digoxin; phenytoin; phenobarbitol; carbamazepine; vancomycin; gentamycin; theophylline; valproic acid; quinidine; luteinizing hormone (LH); follicle stimulating hormone (FSH); estradiol, progesterone; C-reactive protein; lipocalins; IgE antibodies; cytokines; vitamin B2 micro-globulin; glycated hemoglobin (Gly. Hb); cortisol; digitoxin; N-acetylprocainamide (NAPA); procainamide; antibodies to rubella, such as rubella-IgG and rubella IgM; antibodies to toxoplasmosis, such as toxoplasmosis IgG (Toxo-IgG) and toxoplasmosis IgM (Toxo-IgM); testosterone; salicylates; acetaminophen; hepatitis B virus surface antigen (HBsAg); antibodies to hepatitis B core antigen, such as anti-hepatitis B core antigen IgG and IgM (Anti-HBC); human immune deficiency virus 1 and 2 (HIV 1 and 2); human T-cell leukemia virus 1 and 2 (HTLV); hepatitis B e antigen (HBeAg); antibodies to hepatitis B e antigen (Anti-HBe); influenza virus; thyroid stimulating hormone (TSH); thyroxine (T4); total triiodothyronine (Total T3); free triiodothyronine (Free T3); carcinoembryoic antigen (CEA); lipoproteins, cholesterol, and triglycerides; and alpha fetoprotein (AFP). Drugs of abuse and controlled substances include, but are not intended to be limited to, amphetamine; methamphetamine; barbiturates, such as amobarbital, secobarbital, pentobarbital, phenobarbital, and barbital; benzodiazepines, such as librium and valium; cannabinoids, such as hashish and marijuana; cocaine; fentanyl; LSD; methaqualone; opiates, such as heroin, morphine, codeine, hydromorphone, hydrocodone, methadone, oxycodone, oxymorphone and opium; phencyclidine; and propoxyhene. Other potential analytes can be described in U.S. Pat. No. 6,436,651 to Everhart, et al. and U.S. Pat. No. 4,366,241 to Tom et al. As used herein, “medium” and “biological sample” can refer to any material that can contain an analyte to be measured. A medium or biological sample can be any body fluid, including blood or any of its components (plasma, serum, etc.), menses, mucous, sweat, tears, urine, feces, saliva, sputum, semen, uro-genital secretions, gastric washes, pericardial or peritoneal fluids or washes, a throat swab, pleural washes, ear wax, hair, skin cells, nails, mucous membranes, amniotic fluid, vaginal secretions or any other secretions from the body, spinal fluid, human breath, gas samples containing body odors, flatulence or other gases, any biological tissue or matter, or an extractive or suspension of any of these.

As used herein, “sensor,” refers to a device that responds to physical stimulus.

As used herein, a “user,” refers to an individual charged with the health or well-being of one or more children, such as a parent or other caregiver, including family member, someone with power of attorney, or other authorized party. Caregivers can also include doctors, nurses, dentists, and other medical staff at a hospital or other care facility, medical and dental insurers, life insurance agencies, pharmacists and any other providers of medications or health care devices or therapies.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment can be used on another embodiment to yield a still further embodiment. Thus, it is intended that the present disclosure includes modifications and variations as come within the scope of the appended claims and their equivalents.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel.

When data is obtained or accessed between a first and second computer system or component thereof, the actual data can travel between the systems directly or indirectly. For example, if a first computer accesses a file or data from a second computer, the access can involve one or more intermediary computers, proxies, and the like. The actual file or data can move between the computers, or one computer can provide a pointer or metafile that the second computer uses to access the actual data from a computer other than the first computer, for instance.

The various computer systems discussed herein are not limited to any particular hardware architecture or configuration. Embodiments of the methods and systems set forth herein can be implemented by one or more general-purpose or customized computing devices adapted in any suitable manner to provide desired functionality. The device(s) can be adapted to provide additional functionality complementary or unrelated to the present subject matter, as well. For instance, one or more computing devices can be adapted to provide desired functionality by accessing software instructions rendered in a computer-readable form. When software is used, any suitable programming, scripting, or other type of language or combinations of languages can be used to implement the teachings contained herein. However, software need not be used exclusively, or at all. For example, some embodiments of the methods and systems set forth herein can also be implemented by hard-wired logic or other circuitry, including, but not limited to application-specific circuits. Of course, combinations of computer-executed software and hard-wired logic or other circuitry can be suitable, as well.

Embodiments of the methods disclosed herein can be executed by one or more suitable computing devices. For instance, as noted in further detail below, a communications system can comprise one or more systems that can provide wireless multimedia content brokerage services. Such system(s) can comprise one or more computing devices adapted to perform one or more embodiments of the methods disclosed herein. As noted above, such devices can access one or more computer-readable media that embody computer-readable instructions which, when executed by at least one computer, cause the at least one computer to implement one or more embodiments of the methods of the present subject matter. Additionally or alternatively, the computing device(s) can comprise circuitry that renders the device(s) operative to implement one or more of the methods of the present subject matter. Furthermore, components of the presently-disclosed technology, such as subscriber databases, can be implemented using one or more computer-readable media.

Any suitable computer-readable medium or media can be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other memory devices, and the like.

The present disclosure also makes reference to the relay of communicated data over one or more communications networks. It should be appreciated that network communications can comprise sending and/or receiving information over one or more networks of various forms. For example, a network can comprise a dial-in network, a local area network (LAN), wide area network (WAN), public switched telephone network (PSTN), the Internet, intranet or other type(s) of networks. A network can comprise any number and/or combination of hard-wired, wireless, or other communication links.

The present disclosure is generally directed to a system for tracking behavior through one or more tracking pods. In this regard, behavior generally describes actions relating to the health and/or well-being of children. The systems described herein allow users to keep detailed records of such behavior. The systems contemplate being able to track the behavior of one or more children by utilizing tracking pods.

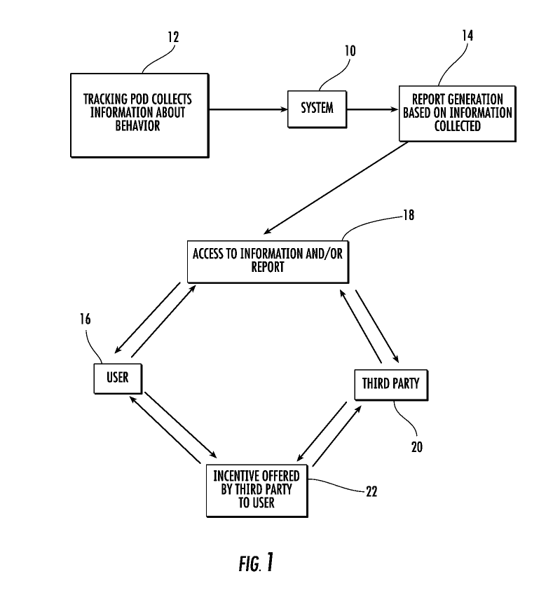

Referring to FIG. 1, the system 10 includes one or more tracking pods 12 to collect information about one or more behaviors. The system 10 generates one or more reports 14 utilizing the information collected. A user 16 can access the information and/or report(s) 18.

In certain embodiments, a third party 20 can also be provided access to the information and/or report(s) 18. The third party 20 can optionally offer an incentive 22 to the user 16 in exchange for access to the information and/or report(s).

The tracking pods described herein can include any of a variety of devices useful in providing information about behavior. The tracking pods can communicate with the systems described herein in a variety of different ways employing any known communications technology, such as Wi-Fi (wireless fidelity), Bluetooth, cellular technology, and the like. Tracking pod signals can be continuous or discrete, and can be taken over a short period of time, over a period of hours or days, or continuously during a prolonged period of time such as a year, and the like.

Each tracking pod can be connected to the system through a network, wherein each tracking pod can be controlled through a local interface, or through a remote interface available through the system. Tracking pods can be readily added or removed from the system without disruption of system functionality. One implementation employs the Jini™ networking protocol (as developed by Sun Microsystems), a description of which can be found at http://www.sun.com/jini (dated Dec. 3, 2007), incorporated herein by reference. The Jini network protocol allows a Jini compatible device to make and break network connections instantaneously upon physical connection and disconnection of the device to the network. Further, communications established in a Jini compatible network allow prompt sharing of information between, and control of, devices after connection. This control of networked devices can be orchestrated through standard Internet and web technology such as the hypertext transfer protocol (e.g., http over TCP/IP). Jini networking protocol and devices can also be used at a remote facility such as a user's home to network tracking pods associated with the present disclosure.

A tracking pod can be placed in any suitable location for detecting a behavior including on or adjacent to the skin or other member of the body. In specifying where tracking pods are placed, it is understood that not all of the tracking pod assembly must be so placed, but that a component thereof is placed in the described location to facilitate measurement. Thus, a component of a tracking pod can be placed in a diaper, while other components, such as a power supply or calibration element, can be located elsewhere.

A tracking pod can be in the form of dedicated hardware for repeat uses, or can be inexpensive and disposable for single use or a small number of repeat uses.

The systems of the present disclosure can display information and/or reports in a manner suitable for reading or interpretation by a user or a third party. For example, a graphical user interface can be utilized that displays qualitative or quantitative information in the form of text, a bar graph, a numerical value, a pie chart, an icon, a color, and so forth, relating to the behavior being tracked. Detailed display of information with interpretative guidance on a computer screen or the like with live hypertext for additional information represents one embodiment of the present disclosure. In other embodiments, a user is provided access to the information via electronic mail, facsimile, or the like. In still other embodiments, a user is provided access to the information via voicemail or a call-in telephone number.

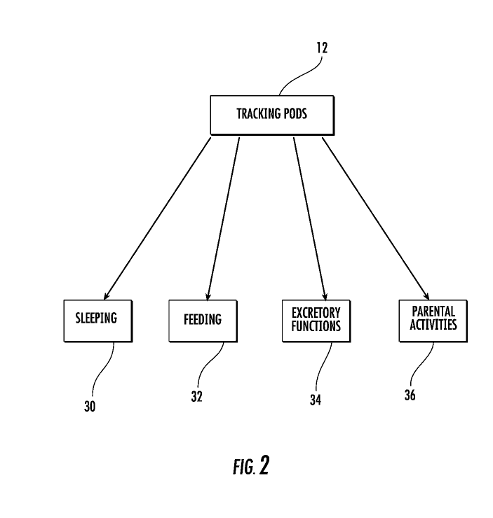

Referring to FIG. 2, the tracking pods 12 can generally be categorized based on different types of behavior including sleeping 30, feeding 32, excretory and bodily functions 34, and parental activities that have a direct relation to a child's health and/or well-being 36. However, it should be understood that other tracking pods can be utilized for activities not specifically mentioned herein. Such tracking pods are contemplated by the present disclosure so long as the activities enable tracking of a behavior that relates to the health and/or well-being of children.

More detail will now be provided with respect to the general categories of tracking pods described above and the various reports that can be generated from the information provided by such tracking pods.

Tracking pods for sleeping can help a user better understand sleep patterns and needs. For example, tracking pods with sleeping sensors can track sleep. Numerous types of sleeping sensors can be implemented to track sleep.

As an example, sleeping sensors can include sleep detectors that can track sleep schedules. For instance, wrist band sleep detectors, and the like, can be utilized to track sleep schedules. Such sleep detectors can often monitor heart rate and body activity to indicate not only when a child is asleep but also when sleep is approaching and the transition from sleep to wake. Sleep detectors can also provide information about overnight wake-ups or brief naps taken during the day. Other types of sleeping sensors can include motion sensors and GPS devices. Motion sensors placed in common sleep locations, such as a child's bed or crib, can be used in connection with sleep detectors to track sleep locations. GPS devices can indicate movement of a child at various times of the day.

The systems of the present disclosure can utilize sleep sensors to chart sleep periods for a child. In addition, the system can produce a sleep probability chart that displays the probability of a child being asleep at a certain time of day. However, it should be understood that other types of reports can also be generated depending on the information the system collects from the tracking pods.

Another type of tracking pod relates to feeding. Tracking pods for feeding can assist a user in better understand eating patterns and nutritional needs. Such tracking pods can provide numerous types of information regarding feeding, including types of foods and/or beverages consumed, time of meal, amounts of food eaten, and the like. Feeding can be tracked by a number of suitable feeding sensors.

As an example, a feeding sensor can be incorporated into a bottle that tracks the amount of liquid consumed by the child as well as the time the child takes to consume the liquid. Similarly, weight sensors can be incorporated into a child's feeding tray or plate to determine the amount of solid food consumed and the time the child takes to consume the meal. The time of day that a child consumes a meal is also capable of being monitored. Through RFID tags, or the like, expiration dates and nutritional information can also be tracked for certain types of food.

The systems of the present disclosure can utilize feeding sensors to chart feeding habits for children. Users can monitor increases or decreases in food consumption based on the information provided by the system. In addition, users can learn a child's likes and/or dislike as well as keep track of food allergies and food variety (a well-balanced diet is important for proper nutrition) through the system.

It should be understood that certain information can also be input by a user into the system through the interface provided by the system. In this regard, it is contemplated that users can access the system through an internet web browser, either on a personal computer or a personal digital assistant (PDA). In addition, access through a cell phone browser is also contemplated by the present disclosure.

Yet another type of tracking pod relates to excretory and bodily functions. Such tracking pods can include various types of excretory sensors.

For example, excretory sensors can be placed in disposable absorbent articles such as diapers, disposable training pants such as HUGGIES® Pull-Ups®, bed pads, briefs, undergarments, or the like. Such excretory sensors can track bowel movements and urine insults as well as the period of time between absorbent article changes, if applicable. Excretory sensors can also be placed in bedding material to track leaks and/or accidents. The information from such excretory sensors can be compiled by the system to indicate excretory patterns.

Excretory sensors can also be placed in other devices for collection or disposal of body fluids and other biological waste matter, as exemplified by the flexible waste bags described in WO 00/65348, which can be flexible receptacles for the containment of excreted fecal matter or urine, and in waste receptacles for diapers or other disposable materials, bedpans, toilet bowls, vomit bags, and the like. Similarly, excretory sensors can be placed in storage containers for the above-described items.

Testing of body fluids for analytes can also be achieved by excretory sensors placed in the articles described above or by other bodily function sensors that can come into contact with any other type of bodily fluid. For example, markers in urine can be detected for bladder cancer (e.g., BLCA-4, a nuclear matrix protein found in the nuclei of bladder cancer cells, a described in Diagnostics Intelligence, v 10, no 5, p. 12). U.S. Pat. No. 6,200,765, issued Mar. 13, 2001 and incorporated herein by reference, discloses a noninvasive method of detecting prostrate cancer using a body fluid sample, which can be urine. Thus, absorbent articles could be equipped with tracking pods for prostrate cancer, bladder cancer, or other cancers.

Bodily function sensors can include multiple sensing elements or other technologies to detect multiple analytes. For example, one can employ the multiple analyte technology of U.S. Pat. No. 6,294,392, “Spatially-Encoded Analyte Detection,” issued Sep. 25, 2001 to Kuhr et al. provides a flow-through microfluidic (e.g., capillary) biosensor for detecting different target analytes (e.g. nucleic acids) in a sample after binding to their cognate “binding partners” (e.g. nucleic acids, antibodies, lectins, etc.). In general, binding partner “probes”, specific to various analytes are immobilized in different sections of a capillary channel, e.g. using photolabile biotin/avidin technology. The sample is then flushed through the capillary, so that the target analytes are bound to the binding partners (capture agents) immobilized on the capillary wall and the rest of the sample is eluted from the capillary. Finally, the complexed (bound) analyte is released along the entire length of the channel and flushed past a detector. In a preferred embodiment, the desorbed, target-analytes are detected at a copper electrode poised downstream using sinusoidal voltammetry (Singhal and Kuhr, Analytical Chemistry, Vol. 69, 1997, pp. 3552-3557; Singhal et al., Analytical Chemistry, Vol. 69, 1997, pp. 1662-1668). The time from the elution of the target analyte(s) to detection is used to determine the identity of each analyte. Multiple analytes, of the same species of molecule (e.g., all nucleic acids), or of different species (e.g. proteins and nucleic acids), can be diagnosed by using a single tracking pod in this manner. The tracking pod can be highly specific due to the use of specific binding partners, and extremely sensitive due to electrochemical detection.

Bodily function sensors can be spaced apart from the body, for measuring compounds in human breath (e.g., an electronic nose) or other body odors, where they can be in vapor communication with the body. Bodily function sensors spaced apart from the body also include those measuring material removed from the body for separate analysis, such as a blood sensor measuring analytes in withdrawn human blood.

Another suitable type of bodily function sensor that can detect analytes in saliva can be used. Examples include products of Salimetrics (State College, Pa.), which provides a suite of salivary enzyme-immunoassay (EIA) kits for analytes such as cortisol (an indicator of stress), DHEA (dehydroepiandrosterone), testosterone, estradiol, progesterone, melatonin, cotinine, neopterin, and sigA (secretory immunoglobulin A). The Male/Female Testosterone Profile test kit and the Post Menopausal Panel (for hormone detection) of are also a saliva-based system. Saliva-based fertility testing devices are also commercially available for predicting the time of ovulation, including the “Lady Fertility Tester” distributed by Med-Direct.com. All of the information referred to above can be located by a user through the system.

Still another type of tracking pod relates to parental activities that have a direct relation to a child's health and/or well-being. Such tracking pods can include ancillary sensors. For example, sensors can be placed in a pillbox or medicine cabinet to track medicine dosages administered by a parent or caregiver. RFID tags on medicine containers can provide dosage and expiration information to the system. Another type of ancillary sensor can include a breast pump sensor. A user can track the amount and age of breast milk that has been expressed.

Another type of ancillary sensor can include test devices for detecting pregnancy or the onset of ovulation, any of which can be adapted for the present disclosure. Basal temperature measurements and urine LH (luteinizing hormone) kits represent two common technologies. Monitoring Follicle Stimulating Hormone with biosensors in absorbent articles to track the onset of ovulation is suggested in the following U.S. patent applications: Ser. No. 09/299,399, filed Apr. 26, 1999; Ser. No. 09/517,441, filed Mar. 2, 2000; and Ser. No. 09/517,481, filed Mar. 2, 2000; each of which was previously incorporated by reference. Such sensors allow a user to track pregnancy attempts using the system of the present disclosure.

The above description provides examples of exemplary tracking pods for use in connection with the present disclosure. However, it should be understood that other types of tracking pods are also contemplated and within the scope and spirit of the present disclosure. Examples of other tracking pods can be found in U.S. Patent App. No. 2005/0101841 A9 to Kaylor, et al., which is incorporated by reference herein.

In certain embodiments of the present disclosure, the systems are adapted to make recommendations to a user based on the data received from the tracking pod. In addition, the systems of the present disclosure can store and archive information received from the tracking pods. In this manner, the systems can make recommendations to a user based on historical data stored by the systems. For example, the systems can correlate data and determine that when a child eats a large snack before bedtime, the data indicates that the child is unlikely to sleep well. Such information can be useful to a user in evaluating behaviors.

As stated previously, in certain embodiments of the present disclosure, a third party can be authorized to access the system and information described herein. For example, a doctor can be authorized to review current and/or past tracking pod information.

In other embodiments of the present disclosure, the user can agree to share information from the system in exchange for an incentive. Such an incentive can include a discount or rebate for a product relating to the behavior being tracked (i.e. discount or rebate for HUGGIES® diapers).

In such embodiments of the present disclosure, behavior tracking can allow for data to be provided to product manufacturers and can be utilized to determine product utility, potential product design revisions, and marketing insights.

In certain embodiments, questions can be posed to a user of the system by way of any of the user access methods described previously. A user can be offered incentives for answering the questions, which can provide invaluable insights to product manufacturers regarding product utility and marketing. An example of this would be if a questionnaire showed a user is actively pursuing toilet training, the system could introduce the concept of training pants and offer coupons to entice the user to try a product.

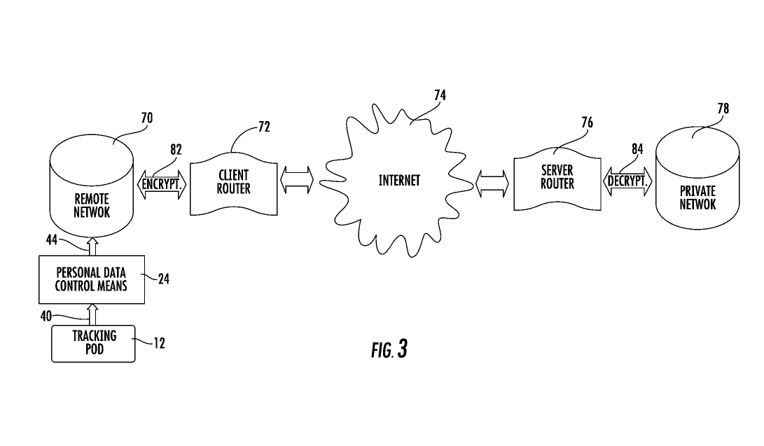

FIG. 3 shows one system for sharing of information from a tracking pod 12 with a central network in a way that protects the security of the data. The response signal 44 from the personal data control means 24 provides data to a remote network 70, which can include a lone data transmission device that can be part of the personal data control 24. The remote network 70 provides the data in the form of a signal to a client router 72, with an intermediate encryption step 82 occurring to encrypt the data. The encryption step 82 can also include decryption of a signal received from another source via the client router 72. The client router 72 directs a signal including the encrypted data over the Internet 74 to a server router 76, which provides the signal to a private network 78 with an intermediate decryption step 84. The decryption step 84 can also include encryption for a signal sent from the private network 78 to another source such as the remote network 70. The private network 78 can form part or all of the data allocation and processing module 26 (not shown). In this process, a secure tunnel can be provided between the client router 72 and server router 76, as explained at www.linuxdoc.org/HOWTO/PN-HOWTO-2.html#ss2.1. To establish the secure tunnel, any suitable method can be used, including Point-to-Point Tunneling Protocol (PPTP). User settings determine the level of privacy, and can be adapted more specifically for the needs of the present disclosure.

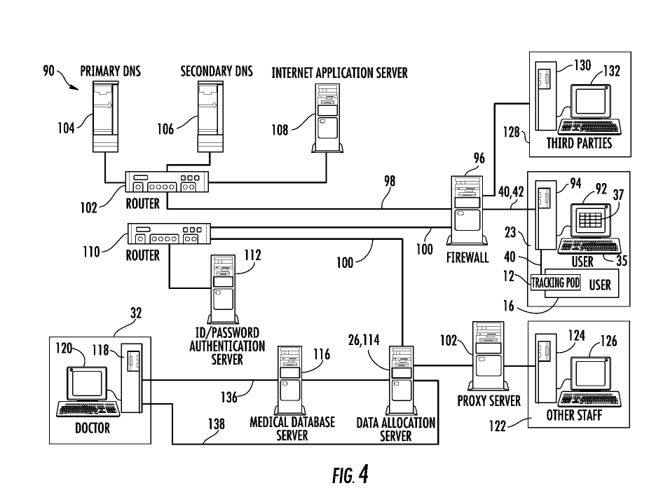

FIG. 4 depicts one embodiment of a computer network 90 supporting the system of the present disclosure. Communication between the computer 94 of the user 16 with the computer network 90 can be provided via a Web-based interface beginning. Upon entering a predetermined URL for the Web page, the URL request is sent via the firewall to a Cisco router 102, which employs either a primary domain name server (DNS) 104 or a secondary DNS 106 to determine the IP address to be used for the requested URL. A signal is then sent to an Internet application server 108, which generates a signal to create a Web page display. The signal is routed back to the computer 94 of the user 16 such that a Web page is displayed on a monitor 92. The displayed Web page requires the user to log in using a user ID and password (or other authentication means such as biometrics). When the user ID and password are entered, that information is routed again through the firewall 96 to a second Cisco router 110 that directs the information to an ID/password authentication server 112 (e.g., an SQL server). If a valid user ID and password have been entered, a welcome page for the computer network 90 is then displayed (e.g., a signal is sent to the Internet application server 108 which then sends a signal back to the computer 94 of the user 16 to display the computer network welcome page). The welcome page displayed after logging in can be unique to the user 16 and can provide access to additional pages that contain information about tracking pod(s) 12, including default settings for access to data and distribution of data, tracking pod 12 information, and so forth. This information can be stored on the Internet application server 108 or a data allocation server 114, and/or the computer 94 of the user 16.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure so further described in such appended claims.

What is claimed is:

1. A system for tracking behavior, the system comprising at least one computing device adapted to:
receive data from at least one tracking pod, the data indicating a behavior;
generate at least one report utilizing at least a portion of the data; and
provide a user access to the data and the at least one report.

2. The system set forth in claim 1, wherein a computing device is further adapted to make recommendations to a user based on the data.

3. The system set forth in claim 1, wherein a tracking pod comprises a sleep sensor.

4. The system set forth in claim 1, wherein a tracking pod comprises a feeding sensor.

5. The system set forth in claim 1, wherein a tracking pod comprises an excretory waste sensor.

6. The system set forth in claim 1, wherein a tracking pod comprises an ancillary sensor.

7. The system set forth in claim 1, wherein a computing device is further adapted to make recommendations to a user based on historical data, the historical data comprising data indicating at least one behavior that was received from at least one tracking pod and stored by a computing device.

8. The system set forth in claim 1, wherein a computing device is further adapted to provide at least one of the data and the at least one report to a third party.

9. The system set forth in claim 1, wherein a computing device is further adapted to provide a user with incentives.

10. The system set forth in claim 1, wherein the user access comprises a graphical user interface that includes advertisements.

11. The system set forth in claim 1, wherein the user access comprises a graphical user interface that includes reference information relating to a behavior tracked by a tracking pod.

12. The system set forth in claim 1, wherein the user access comprises a graphical user interface that includes information about a product relating to a behavior tracked by a tracking pod.

13. The system set forth in claim, wherein data is received from more than one tracking pod.

14. A method of tracking behavior, the method comprising:
receiving data from a tracking pod, the data indicating a behavior;
generating a report utilizing at least a portion of the data; and
providing a user access to the data and the report.

15. The method set forth in claim 14, further comprising making recommendations to a user based on the data.

16. The method set forth in claim 14, further comprising providing at least one of the data and the report to a third party.

17. The method set forth in claim 14, further comprising providing a user with incentives.

18. The method set forth in claim 17, wherein the incentives comprise coupons for products relating to the behavior tracked by the tracking pod.

19. The method set forth in claim 17, wherein the incentives comprise rebates for products relating to the behavior tracked by the tracking pod.

20. A method of tracking behavior, the method comprising:
receiving data from a tracking pod, the data indicating a behavior;
generating a report utilizing at least a portion of the data;
providing a user access to the data and the report; and
providing the user an option to receive incentives if the user agrees to allow at least one of the data and the report to be provided to a third party.

21. The method set forth in claim 20, wherein the incentives comprise coupons for products relating to the behavior tracked by the tracking pod.

22. The method set forth in claim 20, wherein the incentives comprise rebates for products relating to the behavior tracked by the tracking pod.

23. The method set forth in claim 20, further comprising providing the user an option to receive incentives if the user agrees to answer questions.

24. The method set forth in claim 23, wherein the questions relate to the behavior tracked by the tracking pod.

25. The method set forth in claim 20, further comprising providing information about a product relating to the behavior tracked by the tracking pod.
